(19) United States
(12) Patent Application Publication
(10) Pub. No.: US 2009/0052444 A1
(43) Pub. Date: Feb. 26, 2009

(54) METHODS, SYSTEMS, AND COMPUTER PROGRAM PRODUCTS FOR PROVIDING MULTI-SERVICE COMMUNICATION NETWORKS AND RELATED CORE NETWORKS

(75) Inventor: Deron Ringen, Acworth, GA (US)

Correspondence Address: AT&T Legal Department;Attn: Patent Docketing, Room 2A-207, One AT&T Way, Bedminster, NJ, 07921, US

(73) Assignee: AT&T BLS Intellectual Property, Inc.

(21) Appl. No.: 11/844,639

(22) Filed: Aug. 24, 2007

(51) Int. Cl. H04L 12/56

(52) U.S. Cl. 370/389

(57) ABSTRACT

A network includes a plurality of routers that define a core network. The core network is configured to establish a logical connection between ones of a plurality of physically interconnected network nodes to route data packets therebetween. The core network is configured to establish the logical connection based on a logical topology that directly corresponds to a physical topology defined by a layout of physical interconnections between the plurality of nodes. Related methods, devices, and computer program products are also discussed.

### FIELD OF THE APPLICATION

The present application relates to communications networks and methods of operating the same.

### BACKGROUND

Multiprotocol Label Switching (MPLS) is a networking protocol in which network nodes may forward data packets based upon labels appended to each packet. With reference to the Open Systems Interconnection (OSI) model, MPLS can integrate Layer 2 (data link) and Layer 3 (network) routing and, as such, can form a bridge between connectionless IP (Internet Protocol) networks to connection-oriented networks, such as ATM (Asynchronous Transfer Mode) networks, frame relay networks, and/or optical networks (e.g., a Synchronous Optical Network, or SONET). By forming a bridge between IP and Layer 2 technologies, such as ATM, MPLS may be used to provide hybrid IP and ATM (or frame relay) networks. Thus, MPLS may make available to the network layer (e.g., the IP layer) many capabilities (e.g., Quality of Service, or QoS, and traffic management) that traditionally existed at Layer 2.

The MPLS protocol is defined by a family of specifications promulgated by the Internet Engineering Task Force (IETF) and available at “http://www.ietf.org/”. Specifications defining the MPLS protocol include, for example, IETF Request for Comments (RFC) 3031, Multiprotocol Label Switching Architecture (2001), and IETF RFC 2702, Requirements for Traffic Engineering Over MPLS (1999). It should be understood, however, that the above-listed documents are but a few examples of specifications relating to MPLS and, further, that other aspects of MPLS may be described in other specifications.

MPLS may provide the ability to build virtual circuits across a network using one or more of the aforementioned labels. A virtual circuit through an MPLS network may include a series of nodes, including an ingress node, one or more intermediate nodes, and an egress node. The nodes at the edges of the MPLS network—i.e., the ingress and egress nodes—may be referred to as Label Edge Routers (or LERs), whereas the intermediate nodes may be referred to as Label Switching Routers (or LSRs). The LERs couple the MPLS network with other, external networks, whereas the LSRs form the core of the MPLS network.

An MPLS label may include an identifier (e.g., a number of bits) that represents a packet's Forwarding Equivalence Class (FEC), which may indicate that a group of packets are forwarded in a similar manner (e.g., over the same network path). The MPLS label in a packet can serve as an index into a forwarding table, which specifies the next node, or next hop, for the packet. The path associated with a virtual circuit within an MPLS network, which may be referred to as a Label Switched Path (or LSP), may be delineated by one or more MPLS labels that may be, at various times, encapsulated into packets propagating over this path. Accordingly, an MPLS network may be referred to as “connection oriented”, because for each packet stream to traverse the network, a connection (i.e., a LSP) may be set up by a protocol. Also, because of the ability to create LSPs through an MPLS network, MPLS may support priority-based routing—e.g., QoS and/or Class of Service (CoS)—as well as traffic engineering schemes.

As noted above, the path of a packet through an MPLS network may be defined by MPLS labels. These labels may include information that may be used to determine a packet's route through the network. Accordingly, other than examining a label to determine the next hop for a packet, the nodes within the MPLS network (e.g., the LSRs) may not make routing decisions. A packet arriving at an ingress LER of an MPLS network may receive a label indicating the packet's first hop in the network. When the packet is received at an LSR within the core of the MPLS network, the LSR may simply remove (or “pop”) the label from the packet and then replace (or “swap”) that label with another label. As the packet travels through the MPLS network, that packet may, at any time, have multiple labels (i.e., a “label stack”) that have been encapsulated within the packet. When the packet reaches the edge of the MPLS network, the egress LER may “pop” remaining labels from the label stack in order to make a forwarding decision for the packet. Should a packet received at the egress LER contain a label stack, rather than a single label, the egress LER may “look” at each label in the stack one-by-one in order to determine what action to take with respect to the packet.

Each node in an MPLS network may maintain a forwarding table including an Incoming Label Mapping (ILM) table and a Next Hop Label Forwarding Entries (NHLFE) table. The ILM table at a given node may map each incoming label at that node to an associated action and/or to an entry in the NHLFE table, which may specify the next-hop for an incoming packet. For example, when a packet is received at an MPLS network node, a look-up may be performed in that node's ILM table based upon the label of the incoming packet. The entry of the ILM table corresponding to the incoming label may specify an action, such as “swap”, and this ILM table entry may map to an entry in the NHLFE table. The entry of the NHLFE table may specify a new label that is to replace the incoming label and/or may specify an outgoing port. An egress LER of an MPLS network may not include an NHLFE table, as the next-hop may not be within the MPLS network. Thus, a look-up in that LER's associated ILM table can inform the egress LER how to forward or otherwise dispose of a labeled packet.

### SUMMARY

According to some embodiments, a method for providing a network service includes determining a layout of physical interconnections between a plurality of interconnected network nodes, and establishing a logical connection to route data packets between ones of the plurality of nodes to provide the network service therebetween. The logical connection is established based on a logical topology that directly corresponds to a physical topology defined by the layout of the physical interconnections between the plurality of nodes.

In some embodiments, the logical connection may be established based on a shortest physical path between the ones of the plurality of nodes. In other embodiments, the logical connection may be established to route the data packets between the ones of the plurality of nodes without knowledge of a network service that is associated with the data packets.

According to further embodiments, a method for providing multiple services over a network includes providing a first end-to-end logical connection to route data packets associated with a first service between ones of a first set of service modules, and providing a second end-to-end logical connection to route data packets associated with a second service that is different from the first service between ones of a second set of service modules. The first and second sets of service modules terminate customer connections. As such, a first service is provided over the first logical connection without knowledge of the first service associated with the data packets, and a second service that is different from the first service is provided over the second logical connection without knowledge of the second service associated with the data packets.

In some embodiments, the first and/or second logical connections may be established based on a logical topology that directly corresponds to a physical topology defined by a layout of physical interconnections between the first and second sets of service modules.

According to still further embodiments, a system includes a plurality of core routers that define a core network configured to establish a logical connection to route data packets between ones of a plurality of physically interconnected network nodes to provide a network service therebetween. The core network is configured to establish the logical connection based on a logical topology that directly corresponds to the physical topology defined by a layout of physical interconnections between the plurality of nodes.

In some embodiments, the core network may be configured to establish a logical connection based on a shortest physical path between the ones of the plurality of nodes. In other embodiments, the core network may be configured to establish the logical connection and route the data packets between the ones of the plurality of nodes without knowledge of a network service that is associated with the data packets.

According to other embodiments, a multi-service communication network includes a first set of service modules, a second set of service modules, and a core network. The first and second sets of service modules are configured to terminate customer connections. The first set of service modules respectively include a plurality of network elements dedicated to providing a first service. The second set of service modules respectively include a plurality of network elements dedicated to providing a second service that is different from the first service. The core network includes a plurality of routers connected to the first and second sets of service modules. The plurality of routers are configured to provide first and second end-to-end logical connections through the core network to route data packets between the first and second sets of service modules, respectively, without knowledge of the first and/or second services associated with the data packets.

In some embodiments, the core network may be configured to provide the first and second logical connections based on a logical topology that directly corresponds to a physical topology defined by a layout of physical interconnections between the first and second sets of service modules.

According to still other embodiments, a service module for use in a multi-service communication network includes at least one network element configured to terminate a customer connection to provide a network service thereto. The at least one network element of the service module is configured to be connected via a network to another service module that is configured to provide a same network service in a manner such that a control plane for the network service is substantially transparent to the network.

In some embodiments, the at least one network element may be configured to only perform functions related to providing the network service. In other embodiments, the at least one network element may be configured to be updated remotely without substantially affecting the network service provided thereby and/or customer premises equipment connected thereto.

Other methods, systems, devices, and/or computer program products according to other embodiments will become apparent to one with skill in the art upon review of the following drawings and detailed description. It is intended that all such additional methods, systems, devices, and/or computer program products be included within this description, be within the scope of the present invention, and be protected by the accompanying claims.

### BRIEF DESCRIPTION OF THE DRAWINGS

FIG. 1 is a schematic diagram illustrating a multi-service communication network according to some embodiments.

FIG. 2 is a schematic diagram illustrating a core network according to some embodiments.

FIG. 3 is a schematic diagram illustrating a service module for use in a multi-service communication network according to some embodiments.

FIGS. 4A and 4B are flowcharts illustrating example network operations according to some embodiments.

### DETAILED DESCRIPTION OF EMBODIMENTS

The present invention now will be described more fully hereinafter with reference to the accompanying drawings, in which illustrated embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items, and may be abbreviated as “/”.

It will also be understood that, although the terms first, second, etc. may be used herein to describe various elements, these elements should not be limited by these terms. These terms are only used to distinguish one element from another. For example, a first receiving station could be termed a second receiving station, and, similarly, a second receiving station could be termed a first receiving station without departing from the teachings of the disclosure.

As used herein, the terms “packet” or “data packet” refer to a unit of information and/or a block of data that may be transmitted electronically as a whole or via segments from one device and/or network location to another. Accordingly, as used herein, the terms “packet” or “data packet” may encompass such terms of art as “frame” and/or “message,” which may also be used to refer to a unit of data transmission.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Multiservice communication networks according to some embodiments may be provided in the form of a single network that supports multiple services based on the transmission of data packets. The services may include, but are not limited to, Internet access, e-commerce, e-mail, corporate data processing, video, and/or voice services. In particular, a multiservice communication network according to some embodiments may include a core network including a plurality of core routers with relatively high bandwidth transport therebetween that connects sets of service modules to provide particular network service. The core routers may transport data packets between service modules according to a logical topology that is based on the layout of the physical interconnections between nodes of the network, and, in some embodiments, may dynamically set up end-to-end connections based on a shortest physical path through the core network.

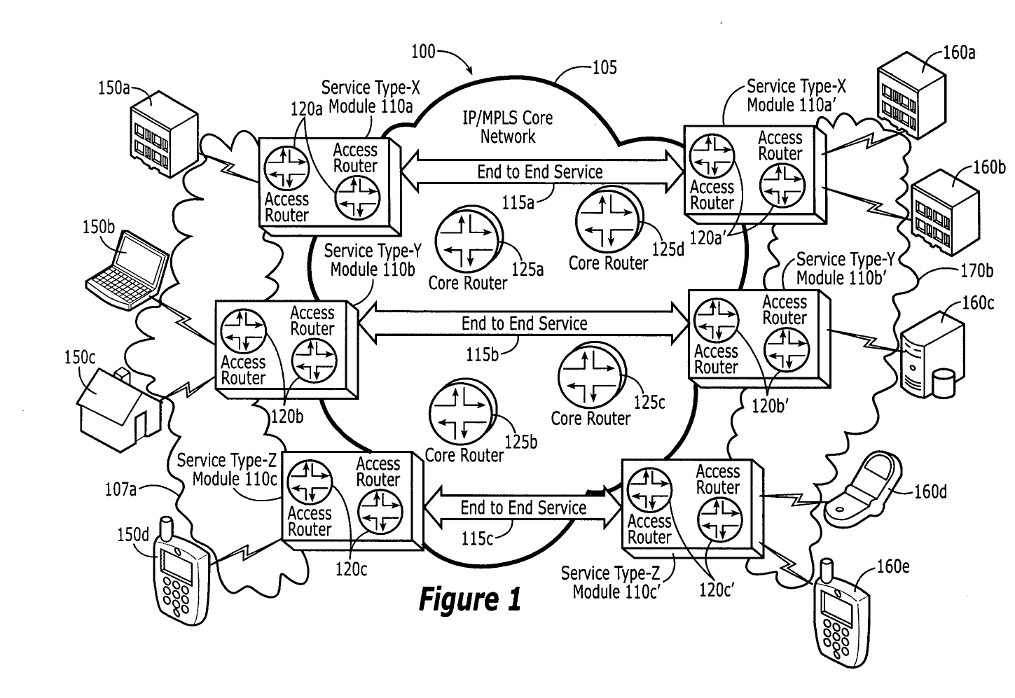

FIG. 1 illustrates a multi-service communication network according to some embodiments. As shown in FIG. 1, a multiservice communication network 100 includes a core network 105 and a plurality of service modules 110a-110c and 110a′-110c′. The service modules 110a-110c and 110a′-110c′ are configured to provide network services, such as Internet access, e-mail, and/or voice services to a plurality of customers 150a-150d and 160a-160e via networks 107a-107b. The service modules 110a-110c and 110a′-110c′ are configured to terminate customer connections, and respectively include one or more network elements that are dedicated to providing a particular network service. The network elements may include routers, switches, servers, and/or other equipment configured to perform functions relating to providing the particular network service. Each pair of service modules 110a/110a′, 110b/110b′ and 110c/110c′ is configured to be connected via the core network 105, and is configured to provide a different network service.

More particularly, as shown in FIG. 1, service modules 110a and 110a′ include network elements 120a and 120a′ configured to perform functions relating to providing e-mail service to customers 150a, 160a, and 160b. In addition, service modules 110b and 110b′ include network elements 120b and 120b′ configured to perform functions relating to providing an Internet service to customers 150b, 150c, and 160c. Also, service modules 110c and 110c′ include network elements 120c and 120c′ configured to perform functions relating to providing a voice over Internet Protocol (VoIP) service to customers 150d, 160d, and 160e. In some embodiments, the network elements of each service module may be dedicated to providing only one service. More particularly, the network elements 120a and 120a′ may be configured to only perform functions relating to the e-mail service, the network elements 120b and 120b′ may be configured to only perform functions relating to the Internet service, and the network elements 120c and 120c′ may be configured to only perform functions relating to the VoIP service. In addition, the network elements 120a/120a′, 120b/120b′, and 120c/120c′ of the service modules 110a/110a′, 110b/110b′, and 110c/110c′ may include access routers and/or other interfaces that are configured to be connected to the core network 105. Accordingly, the sets of service modules 110a/110a′, 110b/110b′, and 110c/110c′ may each be dedicated to providing a different network service for the multi-service communication network 100.

The core network 105 includes a plurality of core routers 125a-125d connected to the service modules 110a-110c and 110a′-110c and configured to transmit data packets therebetween to provide the aforementioned services to customers 150a-150d and 160a-160e. More particularly, the core network 105 is configured to establish end-to-end logical connections 115a-115c between service modules that are configured to provide the same service. For example, as shown in FIG. 1, the core network 105 is configured to establish a logical connection 115a between the service modules 110a and 110a′ to route e-mail between customers 150a and 160a. Likewise, the core network 105 is configured to establish a logical connection 115b between the service modules 110b and 110b′ to provide an Internet connection between customers 150b and 160c, and is configured to establish a logical connection 115c between the service modules 110c and 110c′ to provide a VoIP connection between customers 150d and 160e. For services that require bi-directional communication, such as VoIP, it is to be understood that the logical connection between two service modules, such as the connection 115c, may represent a pair of logical connections configured to transmit data in opposite directions between the two service modules.

The core network 105 may represent a global network, such as the Internet, or other publicly accessible network. The core network 105 may also, however, represent a wide area network, a local area network, an Intranet, or other private network, which may not accessible by the general public. Furthermore, the core network 105 may represent a combination of one or more wired and/or wireless public and/or private networks and/or virtual private networks (VPN). The networks 107a and/or 107b may represent local area networks that connect the customers 150a-150d and 160a-160e to the service modules 110a-110c and 110a′-110c′.

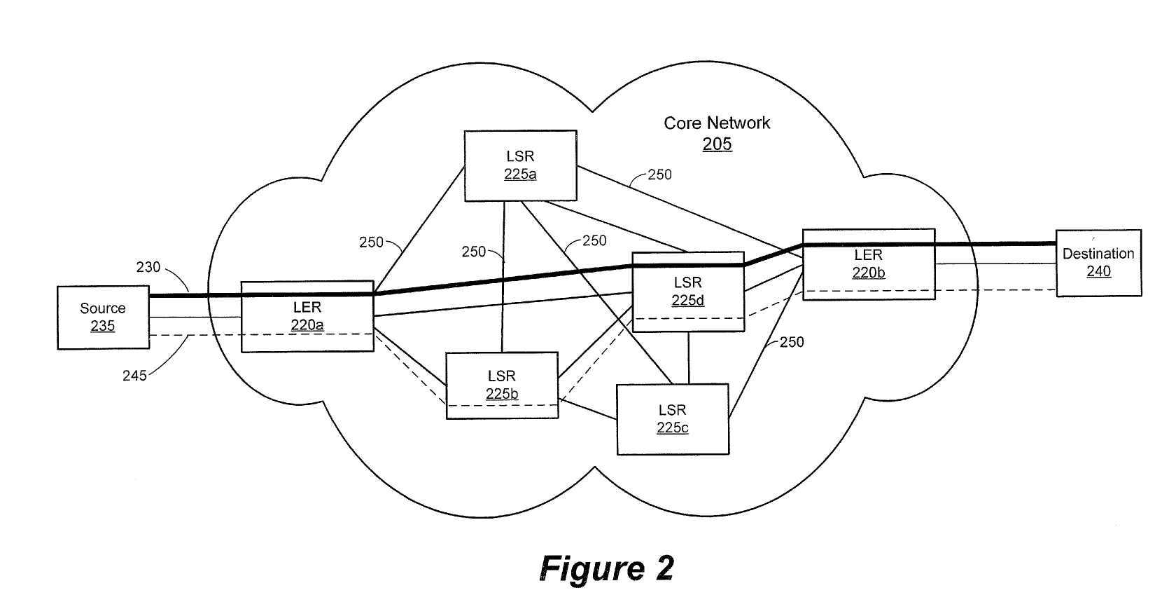

In some embodiments, the core network 105 may be a Multi-Protocol Label Switching (MPLS) network that emulates some properties of a circuit-switched network over a packet-switched network. As such, the core routers 125a-125d may include Label Edge Routers (LERs) at edges of the core network 105 that are configured to be connected to the service modules 110a-110c and 110a′-110c′ as well as Label Switch Routers (LSRs) therebetween that are configured to perform packet routing through the core network 105. More particularly, the LERs and LSRs may be configured to dynamically provide the end-to-end the logical connections 115a-115c as end-to-end label switched paths (LSP) through the core network 105 based on the contents of a topmost label appended to each data packet without examining the contents of the packet itself, as further discussed below with reference to FIG. 2.

Still referring to FIG. 1, the core network 105 may have a logical topology that is based on the physical topology of the interconnections (i.e., cables, wires, etc.) between the service modules 110a-110c and 110a′-110c′. As used herein, ‘physical topology’ refers to the physical layout or arrangement of the elements that connect the various nodes of a network, while ‘logical topology’ refers to the paths over which the data packets are routed through the network. For example, under the Open Systems Interconnect (OSI) model, the physical topology of a network refers to the layout of the fiber optic cable paths at the Layer 1 (physical) level, while the logical topology of the network refers to the flow of data packets between nodes as determined at the Layer 3 (network) level. Examples of network topologies include bus, star, ring, and mesh topologies. Accordingly, the core network may be configured to provide the logical connections 115a-115c based on a logical topology that directly corresponds to the layout of the physical interconnections between the service modules 110a-110c and 110a′-110c′. As such, in some embodiments, the core network 105 may understand and route data packets between the service modules associated with a particular service using the shortest physical path between the service modules. For instance, the core network 105 may be configured to provide the logical connection 115c using the shortest physical path based on the physical layout of the fiber-optic cables between the VoIP service modules 110c and 110c′.

In addition, the core network 105 may be configured to forward data packets between the service modules 110a and 110a′, 110b and 110b′, and 110c and 110c′ via the logical connections 115a, 115b, and 115c without knowledge of the particular service associated with each of the packets. For example, the core network 105 may have no interaction with the control plane of the particular service associated with each packet. As such, the core network 105 may not differentiate between the services associated with the transported data packets, and the services may be provided in a manner that is substantially transparent to the core network 105. Also, the core routers 125a-125d and/or other network elements of the core network 105 may be dedicated to performing only functions related to establishing the logical connections 115a, 115b, and 115c between the service modules 110a/110a′, 110b/110b′, and 110c/110c′, and as such, may not be configured to perform service, customer, and/or outside network-related functions.

Although FIG. 1 illustrates an exemplary multiservice communication network according to some embodiments, it will be understood that the present invention is not limited to such a configuration, but is intended to encompass any configuration capable of carrying out the operations described herein. For example, although the network elements 120a-120c, 120a′-120c′, and 125a-125d are illustrated primarily as routers, it is to be understood that the core network 105 and/or the service modules 110a-110c and 110a′-110c′ may include additional network elements, such as switches, servers, and/or other equipment configured to perform functions relating to providing the particular network services.

FIG. 2 illustrates a core network 205 according to some embodiments. In some embodiments, the core network 205 may correspond to the core network 105 of FIG. 1. Referring now to FIG. 2, the core network 205 includes a plurality of core routers 220a-220b and 225a-225d that are configured to establish logical connections to route data packets between a source node 235 and a destination node 240. More particularly, the core network 205 is a Multi-Protocol Label Switching (MPLS) network including label edge routers (LERs) 220a-220b at edges of the core network 205, and label switch routers (LSRs) 225a-225d configured to route data between the LERs 220a-220b. The LERs 220a-220b are configured to connect the core network 205 to other networks and/or devices, such as the source and destination nodes 235 and 240. In some embodiments, the source and destination nodes 235 and 240 may be a pair of service modules that are configured to provide the same network service, such as the service modules 110a/110a′, 110b/110b′ and 110c/110c′ of FIG. 1. Although only two LERs 220a-220b are illustrated in FIG. 2, it is to be understood that the core network 205 may include numerous LERs connecting the core network 205 to other networks and/or devices according to some embodiments of the present invention.

The core network 205 may be configured to route data packets from the source node 235 to the destination node 240 by appending an MPLS header including one or more labels (also known as a ‘label stack’) to each packet. As shown in FIG. 2, upon receiving a data packet from the source node 235, LER 220a determines which label to prefix to the packet, for example, based on a forwarding equivalence class (FEC) of the packet. The LER 220a requests an end-to-end label Label Switched Path (LSP) (for example, as shown by dotted line 245) to be set up between the LER 220a and the LER 220b, and forwards the packet to one of the LSRs to 225a-225d, which swaps the packet's outer or topmost label for another label, and forwards it to a next one of the LSRs to 225a-225d until it reaches the LER 220b, which may remove the label for the packet and forward the packet to the destination node 240. It should be noted that the LSP 245 may be unidirectional, and as such, the core network 205 may be configured to set up an LSP in the opposite direction such that two LSPs are provided where bidirectional communication is desired. Some embodiments of the present invention may also use Penultimate Hop Popping (PHP), where the outermost label of an MPLS tagged packet is removed by a LSR before the packet is passed to an adjacent LER.

The LERs 220a-220b and LSRs 225a-225d may be configured to route data packets through the core network 205 according to a logical topology that directly corresponds to a physical topology defined by the physical layout of the interconnections 250 between the source and destination nodes 235 and 240. In other words, the path or flow of the data packets through the network 205 may be determined based on the physical layout of the wiring, cables, and/or fiber optic paths through the network 205. As such, the core network 205 may be configured to route data packets between the source and destination nodes 235 and 240 using a shortest physical path between the source and destination nodes 235 and 240. For example, where the physical layout of the interconnections 250 between the LERs 220a-220b and LSRs 225a-225d of the core network 205 connecting the source and destination nodes 235 and 240 define a mesh topology, the core network 205 may establish a logical connection (shown as bold line 230) between the source and destination nodes 235 and 240 based on the shortest physical path between the nodes 235 and 240 provided by the mesh topology. More particularly, the core network 205 may dynamically set up an end-to-end Label Switched Path (LSP) 230 via LER 220a, LSR 225d, and LER 220b to transport MPLS-labeled data packets from the source node 235 to the destination node 240. Accordingly, the core network 205 may employ a logical topology that is configured to provide the shortest physical path between the source and destination nodes 235 and 240. The use of the shortest physical path through the core network 205 may reduce capacity requirements of the underlying Layer 1 and/or Layer 2 networks.

The Layer 1 and/or Layer 2-based transport provided by the fiber optic and/or other physical interconnections 250 may provide relatively high bandwidth connections between the source and destination nodes 235 and 240, for example, based on dense wavelength division multiplexing (DWDM). This may allow for relatively rapid addition of Layer 2-based transport as needed by the core network 205. However, the Layer 1 and/or Layer 2-based transport may be non-protected. As such, in the event of a fault and/or failure at the Layer 1 and/or Layer 2 level, the physical interconnections between the nodes of the core network 205 may not be configured to re-route and/or “self heal”. Rather, routing around a fault and/or failure may be performed at the Layer 3 level by altering the logical interconnections (rather than the physical interconnections 250) between LERs 220a-220b and/or LSRs 225a-225d based on the physical topology to provide at least one alternate path between the source and destination nodes 235 and 240. The alternate path may correspond to a next-shortest physical path between the source and destination nodes 235 and 240. For example, in the event of a fault and/or failure between LER 220a and LSR 225d, the core network 205 may dynamically set up a different end-to-end LSP (shown by dotted line 245) via LER 220a, LSR 225b, LSR 225d, and LER 220b to transport MPLS-labeled data packets from the source node 235 to the destination node 240.

The core routers 220a-220b and 225a-225c and/or other network elements of the core network 205 may be manufactured and/or otherwise provided by at least two different vendors. Accordingly, in some embodiments, at least two vendors may be certified for each role within the core network 205. As such, the core network 205 may be somewhat protected in the event of a software and/or hardware flaw in equipment from a particular vendor. Also, although not shown, the core network 205 may further include redundant core routers and/or other network elements configured to re-route data packets between the source and destination nodes 235 and 240 such that single element and/or transport link faults/failures may be detected and routed around to reduce and/or avoid adverse effects on the service provided thereby.

Still referring to FIG. 2, the core network 205 may be service-agnostic; that is, the core routers 220a-220b and 225a-225c may be configured to establish the logical connections to route data packets between the source and destination nodes 235 and 240 without knowledge of the service(s) associated with the data packets. As such, the core network 205 may have no interaction with the control plane of the service(s) carried thereby. In addition, the core routers 220a-220b and 225a-225c and/or other network elements of the core network 205 may be dedicated to performing only functions related to the roles of the core network 205. Accordingly, the core routers 220a-220b and 225a-225c and/or other network elements of the core network 205 may not be configured to perform service, customer, and/or outside network-related functions, such as IP forwarding. Rather, in some embodiments, the core network 205 may only be configured to perform functions relating to establishing logical connections between the source and destination nodes 235 and 240, for example, as determined from the topmost label stack appended to each MPLS-labeled data packet that enters the core network 205.

In addition, the core network 205 may be configured to forward the data packets between the nodes 235 and 240 based on an Open-Shortest Path First (OSPF) protocol and/or Label Distribution Protocol (LDP). More particularly, the forwarding control plane of the core network 205 may be OSPF and/or LDP-based. LDP is a protocol in which two LSRs exchange label mapping information bidirectionally to build and maintain LSR databases for use in forwarding traffic through MPLS networks. OSPF uses path cost (which is generally determined by the bandwidth) as a metric to provide a shortest path through a network. The OSPF and/or LDP forwarding control plane may use known mechanisms to provide sub-second convergence in some embodiments. The core network 205 is also configured to support the various levels of drop probability of data packets based on control markings of the data packets to provide a desired quality of service (QoS). The QoS mechanisms may engage at times of network congestion, for example, based on contention of the links between the core network elements and/or the service modules.

Although FIG. 2 illustrates an exemplary core network according to some embodiments, it will be understood that the present invention is not limited to such a configuration, but is intended to encompass any configuration capable of carrying out the operations described herein. For example, although described above with reference to particular packet forwarding protocols, other protocols may be used to establish the logical connections between the nodes 235 and 240. In addition, although illustrated primarily as routers, it is to be understood that the core network 205 may include additional network elements configured to perform functions relating routing data packets.

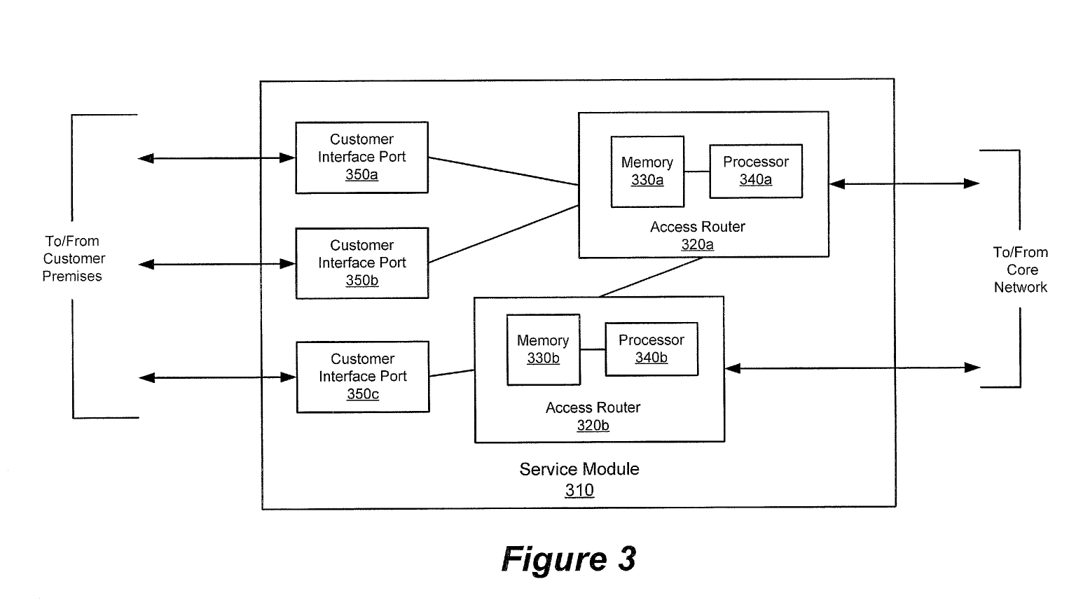

FIG. 3 illustrates a service module 310 according to some embodiments. In some embodiments, the service module 310 may correspond to one of the service modules 110a-110c and 110a′-110c′ of FIG. 1. Referring now to FIG. 3, the service module 310 includes one or more network elements 320a-320b configured to terminate customer connections and provide a network service, such as Internet access, e-commerce, e-mail, corporate data processing, video, or voice service. More particularly, the service module 310 includes access routers 320a and 320b configured to provide a particular network service to one or more customers via customer interface ports 350a-350c. The access routers 320a and 320b respectively include processors 340a and 340b and memories 330a and 330b. The memories 330a and/or 330b may represent a hierarchy of memory that may include volatile and/or non-volatile memory, such as removable flash, magnetic, and/or optical rewritable non-volatile memory. The processors 340a and/or 340b may be, for example, a commercially available or custom microprocessor that is configured to coordinate and manage operations of the access routers 320a and 320b. The access routers 320a-320b are configured to connect the service module 310 to a network, such as the core network 205 of FIG. 2.

The network elements 320a-320b of the service module 310 may be dedicated to providing a single network service via the customer interface ports 350a-350c. As such, the network elements 320a-320b may be configured to only perform functions related to providing the particular service. For example, where the service module 310 is configured to provide VoIP service, the network elements 320a-320b may be configured to only perform functions related to providing the VoIP service via customer interface ports 350a-350c. For example, when a VoIP customer associated with the service module 310 requests a VoIP call to another party, the network elements 320a-320b of service module 310 may be configured to request a network connection with the service module that provides the VoIP service to the desired party, for example, via the core network 105 of FIG. 1. However, the network elements 320a-320b of the service module 310 may not be configured to perform core network functions and/or functions relating to other services, such as e-mail and/or Internet access. Also, the core network may not have knowledge of service-specific control planes, such as a VoIP control plane. Accordingly, the service module 310 may include specific functionality dedicated to providing only one network service, and may be configured to only connect with other service modules that provide the same network service. Other service modules, such as the service modules 110a-110c of FIG. 1, may each be configured to provide a different network service. Thus, the service module 310 along with other service modules may be used to provide a multi-service network architecture where different service modules provide different network services.

Still referring to FIG. 3, one or more of the network elements 320a-320b of the service module 310 may be configured to be updated remotely without substantially affecting the customer premises equipment connected to the service module 310 and/or the particular service provided by the service module 310. For example, the processors 340a and/or 340b of the access routers 320a and/or 320b may be configured to receive remote updates via the network, such as the core network 205 of FIG. 2. More particularly, the processor 340a may be configured to update software stored in the memory 330a without substantially impacting the customer and/or services provided via the customer interface ports 350a and/or 350b. As such, the customer interface ports 350a-350c may be configured to provide the service without substantial interruption during the remote updates. Accordingly, the service module 310 may be configured to provide in-service software upgrades.

In addition, the network elements 320a-320b of the service module 310 may be manufactured and/or otherwise provided by at least two different vendors. More particularly, at least two different vendors may be certified for each service-related role performed by the service module 310. As such, the use of at least two different vendors may somewhat protect the service module 310 from software and/or hardware flaws that may be present in elements provided by one of the vendors. Also, the service module 310 may be configured to support various levels of drop probability for data packets based on the control markings of the data packets to provide a desired quality of service (QoS). The QoS mechanisms may engage at times of congestion and/or on contention on the links between the service module 310 and the customer and/or between the service module 310 and a network, such as the core network 105 of FIG. 1.

Although FIG. 3 illustrates an exemplary service module 310 according to some embodiments, it will be understood that the present invention is not limited to such a configuration, but is intended to encompass any configuration capable of carrying out the operations described herein. For example, although illustrated as including a particular number of the access routers and/or customer interface ports, it is to be understood that the service module 310 may include fewer or more access routers and/or customer interface ports in some embodiments. In addition, the service module 310 may include additional network elements, such as switches, servers and/or other equipment configured to perform functions relating to providing the particular network service.

Computer program code for carrying out operations of devices and/or systems discussed above with respect to FIGS. 1-3 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, systems, electronic devices, and/or computer program products in accordance with some embodiments of the invention.

These flowchart and/or block diagrams further illustrate exemplary operations for providing multi-service communication networks and/or related core networks in accordance with various embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

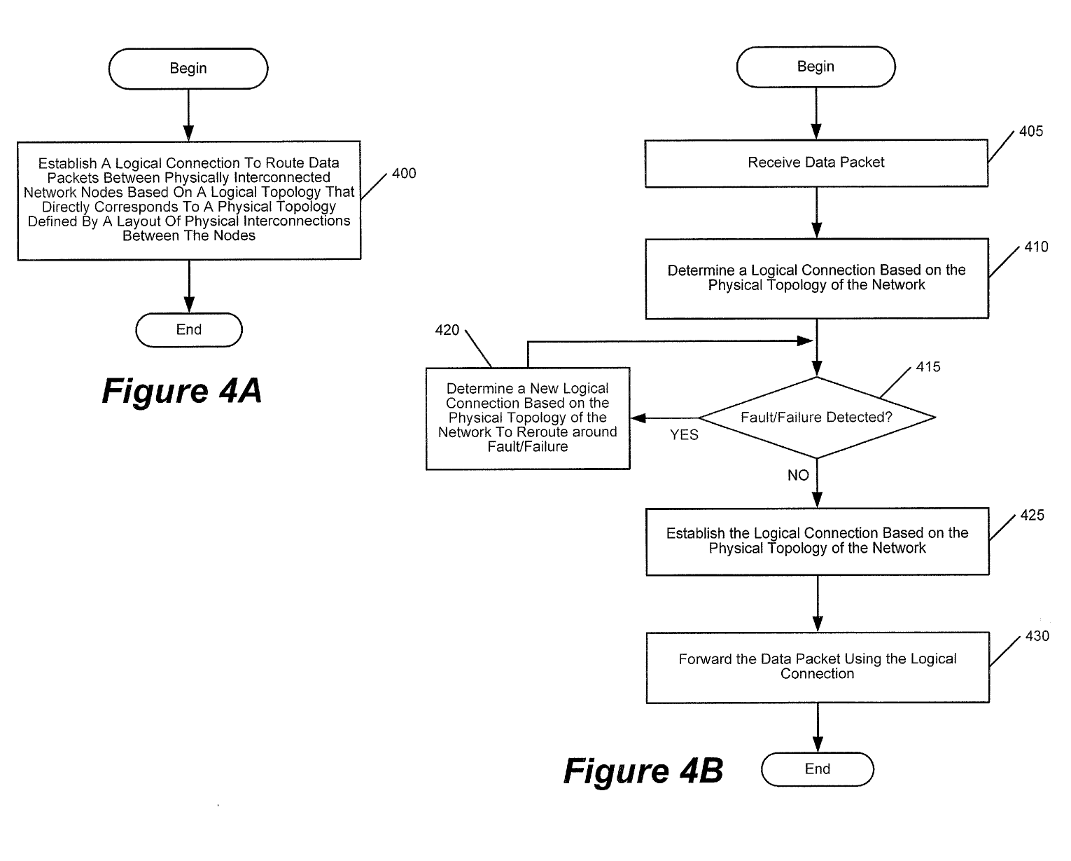

FIGS. 4A and 4B are flowcharts that illustrate exemplary operations in accordance with some embodiments. Referring now to FIG. 4A, a logical connection is established between physically interconnected network nodes to route data packets between the nodes (block 400). The connection is established according to a logical topology that directly corresponds to a physical topology defined by a layout of physical interconnections between the nodes. For example, where the physical interconnections (i.e., cables, wiring, etc.) between the nodes define a mesh topology, a logical connection may be established based on a shortest physical path between the nodes as provided by the mesh topology. As such, capacity requirements on the underlying physical network may be reduced.

FIG. 4B illustrates additional operations according to some embodiments. As shown in FIG. 4B, a data packet is received by a network element (block 405), such as the LER 220a of the core network 205 of FIG. 2. A logical connection through the network is determined to route the data packet to a destination node based on a physical topology of the network (block 410). For example, the logical connection may be determined to provide a shortest physical path to a service module that is dedicated to providing a single network service, such as the service module 310 of FIG. 3. If a fault and/or failure is detected in the network along the determined path (block 415), a new logical connection is determined based on the physical topology of the network to reroute the data packet to the destination node around the fault and/or failure (block 420). For instance, the new logical connection may be determined to provide a next shortest physical path to the destination node. However, if no-fault and/or failure is detected (block 415), a logical connection is established to route the data packet to the destination node (block 425), and the data packet is forwarded to the destination node through the network (block 430). For example, in a multi-service MPLS network according to some embodiments of the present invention, such as the network 100 of FIG. 1, an end-to-end LSP may be dynamically set up to route the data packet through the MPLS network from one service module to another to provide a desired network service (such as e-mail, Internet access, and/or voice service) to a customer.

Accordingly, multi-service communication networks according to some embodiments may include service modules that are each dedicated to providing a single service, and a core network that provides high-bandwidth end-to-end connectivity between service modules associated with the same service without knowledge of the associated services. Thus, a network architecture may be provided that supports multiple services, such as internet access, e-mail, video, and/or voice services.

In the drawings and specification, there have been disclosed exemplary embodiments of the invention, and although specific terms are used, they are used in a generic and descriptive sense only and not for purposes of limitation, the scope of the invention being defined by the following claims.

That which is claimed:

1. A method for providing a network service, the method comprising:
determining a layout of physical interconnections between a plurality of interconnected network nodes; and
establishing a logical connection to route data packets between ones of the plurality of nodes based on a logical topology that directly corresponds to a physical topology defined by the layout of the physical interconnections between the plurality of nodes to provide the network service therebetween.

2. The method of claim 1, wherein establishing the logical connection comprises:
establishing the logical connection between the ones of the plurality of nodes based on a shortest physical path therebetween.

3. The method of claim 2, further comprising:
establishing a new logical connection to re-route the data packets between the ones of the plurality of nodes based on a next-shortest physical path without altering the physical interconnections therebetween when a fault occurs in the shortest physical path.

4. The method of claim 1, wherein establishing the logical connection comprises:
establishing the logical connection to route the data packets between the ones of the plurality of nodes without knowledge of a network service that is associated with the data packets.

5. The method of claim 4, wherein establishing the logical connection comprises:
dynamically providing an end-to-end Label-Switched Path (LSP) between the ones of the plurality of nodes to transport the data packets therebetween based on contents of a topmost label stack appended thereto according to Multi-Protocol Label-Switching (MPLS).

6. The method of claim 1, wherein the plurality of nodes comprises first and second sets of service modules configured to terminate customer connections, and wherein establishing the logical connection comprises:
establishing a first end-to end logical connection between ones of the first set of service modules to provide a first network service; and
establishing a second end-to-end logical connection between ones of the second set of service modules to provide a second network service that is different from the first network service.

7. The method of claim 1, further comprising:
transporting data packets between the ones of the plurality of nodes over the logical connection using Dense Wavelength Division Multiplexing (DWDM).

8. The method of claim 1, further comprising:
providing a desired quality-of-service (QoS) between the ones of the plurality of nodes based on control markings of the data packets.

9. The method of claim 5, further comprising:
forwarding the data packets between the ones of the plurality of nodes over the logical connection based on an Open-Shortest-Path-First (OSPF) protocol and/or Label Distribution Protocol (LDP).

10. A method for providing multiple services over a network, the method comprising:
providing a first end-to-end logical connection to route a first set of data packets associated with a first service between ones of a first set of service modules that terminate customer connections to provide the first service without knowledge of the first service associated with the first set of data packets; and
providing a second end-to-end logical connection to route a second set of data packets associated with a second service that is different from the first service between ones of a second set of service modules that terminate customer connections to provide the second service without knowledge of the second service associated with the second set of data packets.

11. The method of claim 10, wherein providing the first and second logical connections comprises:
establishing the first and/or second logical connections based on a logical topology that directly corresponds to a physical topology defined by a layout of physical interconnections between the first and second sets of service modules.

12. The method of claim 11, wherein providing the first and second logical connections comprises:
establishing the first and/or second logical connections based on shortest physical paths between the first and second sets of service modules.

13. A system for providing a service over a network, comprising:
a first core router; and
a second core router,
wherein the first and second core routers define a core network configured to establish a logical connection to route data packets between ones of a plurality of physically interconnected network nodes based on a logical topology that directly corresponds to a physical topology defined by a layout of physical interconnections between the plurality of nodes to provide the service therebetween.

14. The system of claim 13, wherein the core network is configured to establish the logical connection between the ones of the plurality of nodes based on a shortest physical path therebetween.

15. The system of claim 14, wherein the core network is configured to establish a new logical connection to re-route the data packets between the ones of the plurality of nodes based on a next-shortest physical path without altering the physical interconnections therebetween when a fault occurs in the shortest physical path.

16. The system of claim 13, wherein the first and second core routers are configured to establish the logical connection and route the data packets between the ones of the plurality of nodes without knowledge of a network service that is associated with the data packets.

17. The system of claim 16, wherein the core network comprises a Multi-Protocol Label-Switching (MPLS) network configured to dynamically provide an end-to-end Label-Switched Path (LSP) between the ones of the plurality of nodes to transport the data packets therethrough.

18. The system of claim 13, wherein the core network is configured to perform only functions related to establishing logical connections between the plurality of nodes.

19. The system of claim 13, wherein the first and second core routers are provided by different vendors.

20. A multi-service communication network, comprising:
a first set of service modules configured to terminate customer connections and respectively comprising a plurality of network elements dedicated to providing a first service;
a second set of service modules configured to terminate customer connections and respectively comprising a plurality of network elements dedicated to providing a second service that is different from the first service; and
a core network comprising a plurality of routers connected to the first and second sets of service modules and configured to provide first and second end-to-end logical connections therethrough to route data packets between the first and second sets of service modules, respectively, without knowledge of the first and/or second services associated with the data packets.

21. The network of claim 20, wherein the core network is configured to provide the first and second logical connections between the first and second sets of service modules based on a logical topology that directly corresponds to a physical topology defined by a layout of physical interconnections between the first and second sets of service modules.

22. The network of claim 21, wherein the core network is configured to establish the first and second logical connections between the first and second sets of service modules based on shortest physical paths therebetween.

23. The network of claim 20, wherein the first set of service modules are configured to only perform functions related to the first service, wherein the second set of service modules are configured to only perform functions related to the second service, and wherein the core network is configured to perform only functions related to providing the respective first and second logical connections between the first and second sets of service modules.

24. The network of claim 20, wherein the core network comprises a Multi-Protocol Label-Switching (MPLS) network configured to provide first and second end-to-end Label-Switched Paths (LSPs) therethrough to respectively connect the first set of service modules and the second set of service modules.

25. A service module for use in a multi-service communication network, comprising:
means for terminating a customer connection to provide a network service thereto; and
means for connecting, via a network, to another service module that is configured to provide a same network service in a manner such that a control plane for the network service is substantially transparent to the network.

26. The service module of claim 25, wherein the means for terminating and means for connecting are configured to only perform functions related to providing the network service.

27. The service module of claim 25, wherein the means for terminating and means for connecting are configured to be updated remotely without substantially affecting the service provided thereby and/or customer premises equipment connected thereto.

28. The service module of claim 27, wherein the means for terminating and means for connecting comprise:
a processor configured to receive a remote update via the core network; and
a customer interface port configured to provide the first service without interruption during the remote update.

29. The service module of claim 25, wherein the means for terminating and means for connecting comprise at least two network elements provided by different vendors.

30. The service module of claim 25, wherein the service module is configured to provide a desired quality-of-service (QoS) based on control markings of the data packets.

31. A computer program product for routing data packets in a network, the computer program product comprising:
a computer readable storage medium having computer readable program code embodied in said medium, said computer readable program code comprising:
computer readable program code configured to establish a logical connection between ones of a plurality of physically interconnected network nodes and route data packets therebetween based on a logical topology that directly corresponds to a physical topology defined by a layout of physical interconnections between the plurality of nodes.

32. The computer program product of claim 31, further comprising:
computer readable program code configured to establish the logical connection and route the data packets between the ones of the plurality of nodes without knowledge of a network service that is associated with the data packets.

33. The computer program product of claim 31, further comprising:
computer readable program code configured to establish the logical connection between ones of the plurality of nodes based on a shortest physical path therebetween.

34. The computer program product of claim 33, further comprising:
computer readable program code configured to establish a new logical connection to re-route the data packets between the ones of the plurality of nodes based on a next-shortest physical path without altering the physical interconnections therebetween when a fault occurs in the shortest physical path.
